(19) United States
(12) Patent Application Publication
(10) Pub. No.: US 2026/0361979 A1
(43) Pub. Date: Nov. 12, 2026

(54) METHODS, APPARATUSES AND COMPUTER PROGRAM PRODUCTS FOR AUTOMATED CREATIVE DIVERSIFICATION WITH MULTI-MODAL ARTIFICIAL INTELLIGENCE POWERED ASSET DECOMPOSITION AND RECOMPOSITION

(71) Applicant: META PLATFORMS, INC., Menlo Park, CA (US)

(72) Inventors: Bina Thakkar, Cary, NC (US); Daniel Peter Moller, London (GB); Gabriel Benjamin Mark Shalom, London (GB)

(21) Appl. No.: 19/202,137

(22) Filed: May 8, 2025

(51) Int. Cl. H04N 21/854; H04N 21/442; H04N 21/466; H04N 21/4728; H04N 21/845

(52) U.S. Cl. CPC H04N 21/854; H04N 21/44204; H04N 21/4662; H04N 21/4728; H04N 21/8456

(57) ABSTRACT

A system and method for providing automated creative diversification of content items are provided. The system may analyze subsets of multimedia content of a content item(s) being provided to one or more users associated with a network. The system may automatically determine whether user engagement or user interaction by the one or more users with the a content item(s) is below a predetermined threshold. The system may segment the subsets of multimedia content into a plurality of different images or different videos. The system may automatically generate an updated a content item(s) to obtain one or more new content items based on the segmented plurality of different images or the different videos to provide to the one or more users in response to determining the user engagement or the user interaction by the one or more users with the a content item(s) is below the predetermined threshold.

### TECHNOLOGICAL FIELD

Exemplary aspects of this disclosure may relate generally to methods, apparatuses and computer program products to streamline the process of refreshing content assets on, or associated with, a platform.

### BACKGROUND

Currently, advertising on some existing platforms may often struggle with the volume of asset production expected to achieve optimal diversification of creative content assets. Even some content assets that perform well may eventually fatigue or become dated and obsolete, requiring updating with fresh creative content assets. The people or teams that manage campaigns (e.g., advertisement (ad) campaigns) and which may be exposed to performance insights may be different people or teams that may be responsible for the production of the creative content assets used within the campaigns. This may present the following problems.

The total length of time to ingest insights, such as brief new creative content, developing of new creative content, and to add/provide these insights to a platform may result in windows for performance being missed. The windows for performance being missed may lead to longer refresh cadences than may be optimal, or no creative refreshes at all within a given campaign. Additionally, resourcing barriers in terms of cost or access to updates or to produce net new assets with cross-functional teams and new asset creation may be resource intensive and may be blocked by a platform on these grounds.

In an instance in which new assets for a refresh may be built at the same time as an initial campaign launch of content assets, the new content assets may not be built to be responsive to insights from live campaign performance. Since aspects of a campaign may be pre-planned, there may be opportunities that may be missed to adapt creative content insights that may be generated on the fly for a campaign.

### BRIEF SUMMARY

Some example aspects of the present disclosure may facilitate refreshing creative assets (e.g., content assets) on, or associated with a platform (e.g., a network, a social network, etc.). For instance, the example aspects of the present disclosure may streamline the process of refreshing content assets based on current creative assets associated with a platform. By automating the refresh process, the solutions of the exemplary aspects may efficiently generate several (e.g., hundreds, thousands, etc.) content assets that may align with identity and messaging of an entity. The approaches of the exemplary aspects may save time and conserve resources (e.g., processing resources of a processor/controller of a communication device, network resources (e.g., network bandwidth conservation), etc.) and may ensure consistency in content assets across channels associated with a platform. In some examples, the exemplary aspects of the present disclosure may provide technical improvements (e.g., minimizing jitter/minimizing network traffic) for a network (e.g., system 100 of FIG. 1) or a network device (e.g., network device 160 of FIG. 1) by automating the provision of content assets across the network, in an efficient manner, for example in instances of determined user fatigue with other content, or prior iterations of associated content, across the network. Additionally, the exemplary aspects of the present disclosure may reduce network traffic by improving content asset performance such that a content provider's overall content load across a network may be reduced in an automated manner to minimize bandwidth consumption (e.g., decrease or removal of underperforming content assets relative to user interaction/engagement) across the network. The exemplary aspects of the present disclosure may also be utilized to shorten the duration of videos, video clips, animations or the like (e.g., in an automated manner) which may reduce bandwidth loading, and thus improve network efficiency across a network. The example aspects of the present disclosure may provide the ability to quickly adapt to changing trends (e.g., market trends) such that entities may maintain a strong presence (e.g., visual presence) associated with a platform.

Additionally, the exemplary aspects of the present disclosure may provide creative diversification. For example, by utilizing the exemplary aspects of the present disclosure, entities may create multiple variations of creative assets (e.g., creative content assets) to automate the process of creation of the assets. In this regard, the entities may efficiently generate a diverse range of creative content, such as for example images, videos, text (e.g., multi-lingual text), audio (e.g., multi-lingual audio), without the need for manual intervention.

By utilizing the exemplary aspects of the present disclosure, entities may have the ability to produce high-quality unique content at scale, and may enhance user engagement as well as user interaction and may improve overall performance associated with a platform.

The exemplary aspects of the present disclosure may utilize artificial intelligence (AI) components, and/or machine learning (ML) components to provide automated creative reproduction of content assets (e.g., ads, videos (e.g., video clips, animations, movies), other multimedia content/clips, etc.) associated with a platform/network. The exemplary aspects of the present disclosure may utilize the AI/ML components to provide segmentation of content assets, multimodal recognition (e.g., detecting audio, text, still images, animation, video, etc.) of content assets, as well as semantic understanding (e.g., a tone of the text/objects, positioning of the text/objects) to create different variations of content assets.

The exemplary aspects may provide an end to end pipeline of automated asset modification to provide updates and/or refreshes to current/existing content items. The exemplary aspects may facilitate usage of inputs (e.g., automated inputs and/or user inputs) to generate new versions of still images and/or video content.

The exemplary aspects may also utilize regionalization/localization determinations to determine multilingual (e.g., language) translations of content to generate creative content assets for provision to one more users of a platform, network, or the like.

The AI/ML components of the exemplary aspects may be utilized/implemented by a platform, network, or the like to facilitate distribution of content assets (e.g., refreshed/updated content assets) and consumption of the content assets by end users of a platform, network, or the like to enhance user interaction with the content assets.

In one example of the present disclosure, a method is provided. The method may include analyzing, by a network device, subsets of multimedia content of at least one content item being provided to one or more users associated with a network. The method may further include automatically determining whether user engagement or user interaction by the one or more users with the at least one content item is below a predetermined threshold. The method may further include segmenting the subsets of multimedia content into a plurality of different images or videos. The method may further include automatically generating, by the network device, an updated at least one content item to obtain one or more new content items based on the segmented plurality of different images or the different videos to provide to the one or more users in response to determining the user engagement or the user interaction by the one or more users with the at least one content item is below the predetermined threshold.

In another example of the present disclosure, an apparatus is provided. The apparatus may include one or more processors and a memory including computer program code instructions. The memory and computer program code instructions are configured to, with at least one of the processors, cause the apparatus to at least perform operations including analyzing subsets of multimedia content of at least one content item being provided to one or more users associated with a network. The memory and computer program code are also configured to, with the processor(s), cause the apparatus to automatically determine whether user engagement or user interaction by the one or more users with the at least one content item is below a predetermined threshold. The memory and computer program code are also configured to, with the processor(s), cause the apparatus to segment the subsets of multimedia content into a plurality of different images or videos. The memory and computer program code are also configured to, with the processor(s), cause the apparatus to automatically generate an updated at least one content item to obtain one or more new content items based on the segmented plurality of different images or the different videos to provide to the one or more users in response to determining the user engagement or the user interaction by the one or more users with the at least one content item is below the predetermined threshold.

In yet another example of the present disclosure, a computer program product is provided. The computer program product may include at least one non-transitory computer-readable medium including computer-executable program code instructions stored therein. The computer-executable program code instructions may include program code instructions configured to analyze, by a network device, subsets of multimedia content of at least one content item being provided to one or more users associated with a network. The computer program product may further include program code instructions configured to automatically determine whether user engagement or user interaction by the one or more users with the at least one content item is below a predetermined threshold. The computer program product may further include program code instructions configured to segment the subsets of multimedia content into a plurality of different images or videos. The computer program product may further include program code instructions configured to automatically generate, by the network device, an updated at least one content item to obtain one or more new content items based on the segmented plurality of different images or the different videos to provide to the one or more users in response to determining the user engagement or the user interaction by the one or more users with the at least one content item is below the predetermined threshold.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1 is a diagram of an exemplary network environment in accordance with an example of the present disclosure.

FIG. 2 is a diagram of an exemplary communication device in accordance with an example of the present disclosure.

FIG. 3 is a diagram of an exemplary computing system in accordance with an example of the present disclosure.

FIG. 4 is a diagram illustrating refreshing of creative content assets in accordance with an example of the present disclosure.

FIG. 5 is a diagram illustrating creative diversification of content assets in accordance with an example aspect of the present disclosure.

FIG. 6 is a diagram illustrating creative diversification of content assets associated with localization and/or regionalization in accordance with an example aspect of the present disclosure.

FIG. 7 is a diagram illustrating another example of creative diversification of content assets in accordance with an example aspect of the present disclosure.

FIG. 8 is a diagram illustrating video and audio refresh and diversification of content assets in accordance with an example aspect of the present disclosure.

FIG. 9 illustrates an example of a machine learning framework in accordance with one or more examples of the present disclosure.

FIG. 10 illustrates an example flowchart illustrating operations for providing automated creative diversification of content items/assets in accordance with an example of the present disclosure.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present disclosure will now be described more fully hereinafter with reference to the accompanying drawings, in which some, but not all embodiments of the disclosure are shown. Indeed, various embodiments of the disclosure may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the disclosure. Moreover, the term “exemplary”, as used herein, is not provided to convey any qualitative assessment, but instead merely to convey an illustration of an example. Thus, use of any such terms should not be taken to limit the spirit and scope of embodiments of the disclosure.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of Augmented/Virtual/Mixed Reality.

As referred to herein decomposing of content, a content item, content asset or the like may be conversion of content (or a content item/content asset) to a set of separate text, a graphic(s), an image(s), a video(s) and/or sound files, by extracting or generating discrete, creative input elements from a final composed asset, including for example separate video items (e.g., video shots, video clips), superimposed text, logos, graphics, animations or visual effects, and diegetic or nondiegetic audio including music, ambient noise, dialogue, sound effects and/or the like.

As referred to herein recomposing of content, a content item, content asset or the like may be involve two or more separate creative elements including text, a graphic(s), an image(s), sound and/or video files, or other content, that may be recombined to form one or more new content items incorporating these creative elements.

It is to be understood that the methods and systems described herein are not limited to specific methods, specific components, or to particular implementations. It is also to be understood that the terminology used herein is for the purpose of describing particular embodiments only and is not intended to be limiting.

### Exemplary System Architecture

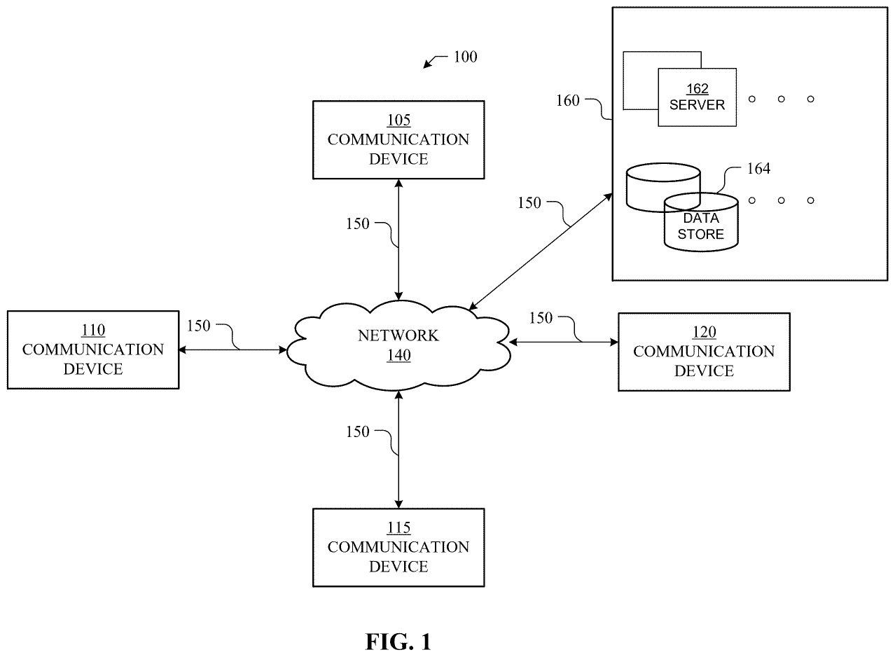

Reference is now made to FIG. 1, which is a block diagram of a system according to exemplary embodiments. As shown in FIG. 1, the system 100 may include one or more communication devices 105, 110, 115 and 120 and a network device 160. Additionally, the system 100 may include any suitable network such as, for example, network 140. In some examples, the network 140 may be a Metaverse network. In other examples, the network 140 may be any suitable network capable of provisioning content and/or facilitating communications among entities within, or associated with the network. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115 and 120 to network 140, network device 160 and/or to each other. This disclosure contemplates any suitable links 150. In some exemplary embodiments, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some exemplary embodiments, communication devices 105, 110, 115, 120 may be electronic devices including hardware, software, or embedded logic components or a combination of two or more such components and capable of carrying out the appropriate functionalities implemented or supported by the communication devices 105, 110, 115, 120. As an example, and not by way of limitation, the communication devices 105, 110, 115, 120 may be a computer system such as for example a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120.

Network device 160 may be accessed by the other components of system 100 either directly or via network 140. As an example and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120 and/or another system (e.g., a third-party system) to manage, retrieve, modify, add, or delete, the information stored in data store 164.

Network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example and not by way of limitation, network device 160 may enable users to interact with each other as well as receive content from other systems (e.g., third-party systems) or other entities, or to allow users to interact with these entities through an application programming interfaces (API) or other communication channels.

It should be pointed out that although FIG. 1 shows one network device 160 and four communication devices 105, 110, 115 and 120, any suitable number of network devices 160 and communication devices 105, 110, 115 and 120 may be part of the system of FIG. 1 without departing from the spirit and scope of the present disclosure.

### Exemplary Communication Device

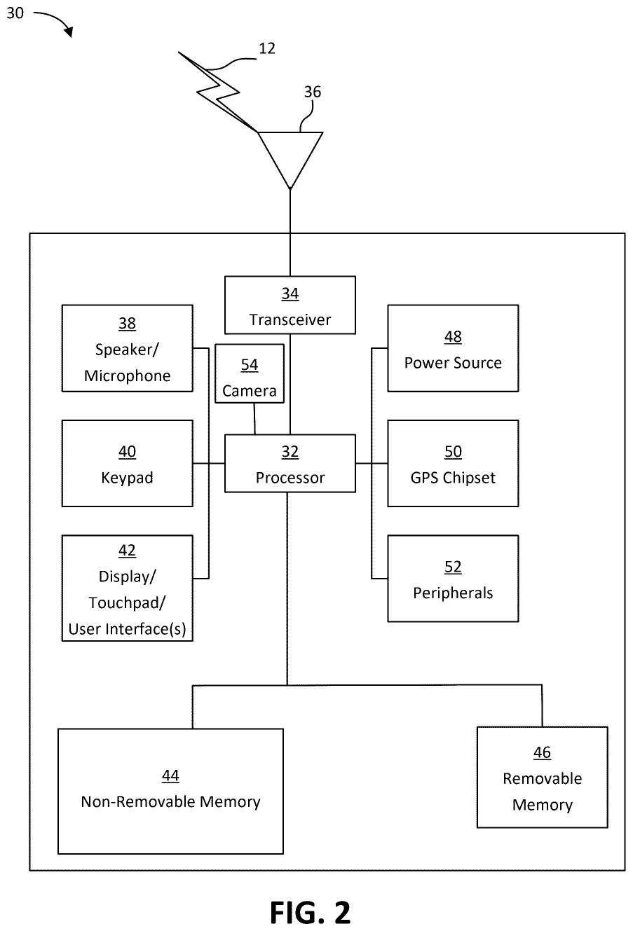

FIG. 2 illustrates a block diagram of an exemplary hardware/software architecture of a communication device such as, for example, user equipment (UE) 30. In some exemplary aspects, the UE 30 may be any of communication devices 105, 110, 115, 120. In some exemplary aspects, the UE 30 may be a computer system such as for example a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, a head-mounted display/device (e.g., a headset), smart watch, charging case, or any other suitable electronic device. As shown in FIG. 2, the UE 30 (also referred to herein as node 30) may include a processor 32, non-removable memory 44, removable memory 46, a speaker/microphone 38, a keypad 40, a display, touchpad, and/or user interface(s) 42, a power source 48, a global positioning system (GPS) chipset 50, and other peripherals 52. In some exemplary aspects, the display, touchpad, and/or user interface(s) 42 may be referred to herein as display/touchpad/user interface(s) 42. The display/touchpad/user interface(s) 42 may include a user interface capable of presenting one or more content items and/or capturing input of one or more user interactions/actions associated with the user interface. The power source 48 may be capable of receiving electric power for supplying electric power to the UE 30. For example, the power source 48 may include an alternating current to direct current (AC-to-DC) converter allowing the power source 48 to be connected/plugged to an AC electrical receptable and/or Universal Serial Bus (USB) port for receiving electric power. The UE 30 may also include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., non-removable memory 44 and/or removable memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, (e.g., non-removable memory 44 and/or removable memory 46) as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

### Exemplary Computing System

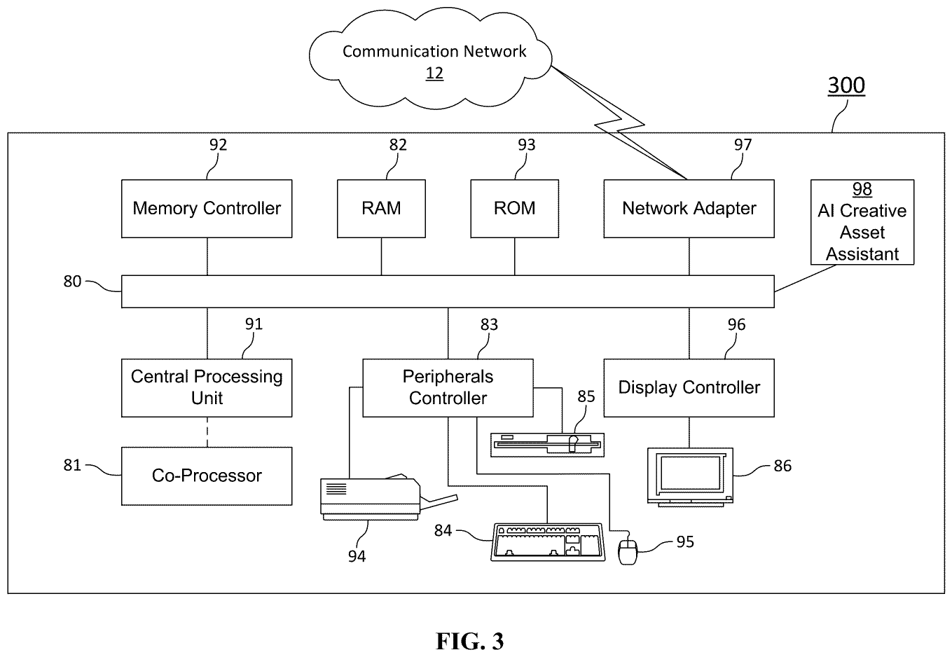

FIG. 3 is a block diagram of an exemplary computing system 300. In some exemplary embodiments, the network device 160 may be a computing system 300. The computing system 300 may include an artificial intelligence (AI) creative asset assistant 98. The computing system 300 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 300 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 300 may contain peripherals controller 83 responsible for communicating instructions from CPU 91 to peripherals, such as printer 94, keyboard 84, mouse 95, and disk drive 85.

Display 86, which is controlled by display controller 96, may be used to display visual output generated by computing system 300. Such visual output may include text, graphics, animated graphics, and video. The display 86 may also include, or be associated with a user interface. The user interface may be capable of presenting one or more content items and/or capturing input of one or more user interactions associated with the user interface. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 300 may contain communication circuitry, such as for example a network adaptor 97, that may be used to connect computing system 300 to an external communications network, such as network 12 of FIG. 2, to enable the computing system 300 to communicate with other nodes (e.g., UE 30) of the network.

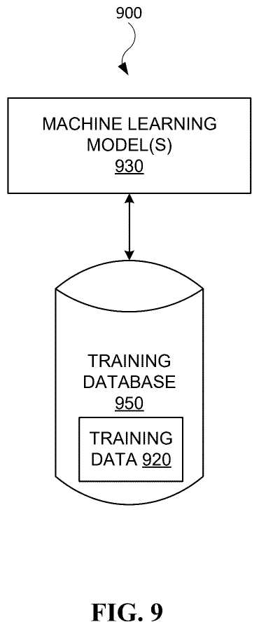

The AI creative asset assistant 98 of the computing system 300 may facilitate creation of content assets associated with a network, platform, system or the like, as described more fully below. For example, the AI creative asset assistant 98 may automate the process of generating multiple variations of creative content assets to provide or automatically generate a diverse range of creative content, such as for example images, videos, text (e.g., multi-lingual text), audio (e.g., multi-lingual audio), without the need for manual (e.g., user) intervention. In some examples, the AI creative asset assistant 98 may implement a machine learning model (e.g., machine learning model(s) 930 of FIG. 9) and/or an AI model that may be pre-trained, trained in real-time, and/or periodically trained with training data (e.g., training data 920 of FIG. 9) to generate the creation of content assets.

### Exemplary System Operation

Some example aspects of the present disclosure may facilitate refreshing creative assets (e.g., content assets) on, or associated with a platform, network (e.g., a network, a social network, etc.), or the like. In this regard, the example aspects of the present disclosure may streamline the process of refreshing content assets based on current creative assets associated with a platform, network or the like. By automating the refresh process associated with content assets, the exemplary aspects may efficiently generate vast amounts of content assets that may align with content asset generation goals of a platform (e.g., system 100), network, or the like.

Additionally, the exemplary aspects of the present disclosure may provide creative diversification by creating/generating multiple variations of creative assets (e.g., creative content assets) to automate the process of the creative assets.

The example aspects of the present disclosure may facilitate creation of more variety of content associated with a platform, network or the like, than conventional/existing systems, and the more differentiated generated content provided across the platform, network or the like, the more likely such content assets may be to impact the target types of audiences that may be most likely to respond, engage, or interact with the content assets. The more instances in which a user views the same content item (e.g., an advertisement (ad)) associated with a platform, or network, the less likely such users may be to interact with the same content item when presented a view of the content item, and as such the content item (e.g., an ad) may be less likely to perform well regarding user interaction with the content item and/or user engagement with the content item. The example aspects of the present disclosure may analyze existing/current content items (e.g., an ad, image, video, movie, animation, etc.) and may create variations to a same content item over time (e.g., periodically during predetermined threshold time periods). In this manner, the exemplary aspects of the present disclosure may automatically generate different versions of content assets (e.g., ads, images, videos, movies, etc.) to present to users of a platform to entice user interaction/engagement with the created content assets.

As described above, the example aspects of the present disclosure may provide refreshing of creative content assets. For purposes of illustration and not of limitation, for example, consider an instance in which an ad of a pastry is presented to communication devices (e.g., UEs 30) of users associated with a platform, network (e.g., system 100), or the like, that presently may need to be refreshed with some other item of content as the ad of the pastry may have user fatigue in that one or more users associated with the network may no longer interact/engage with the pastry ad. For example, the AI creative asset assistant 98 may determine that user engagement/interaction with the pastry ad is below a predetermined threshold of user engagement/interaction. In this regard, the AI creative asset assistant 98 may automatically detect and label/flag content assets that may be determined to have a predetermined level (e.g., less than 60% interest (e.g., user interaction/user engagement) with the content items by users, etc.) of fatigue among users of a network (e.g., system 100). This calculation can be leveraged to trigger an automated update/refresh of the assets. The determination of the user engagement/interaction with a content asset/item (e.g., the pastry ad), by the AI creative asset assistant 98, being below the predetermined threshold of user engagement/interaction may automatically trigger the AI creative asset assistant 98 to generate a new/updated content asset/item to present to one or more users associated with a network.

Consider for example that in a particular geographic area, people no longer like pastries as much for lunch and instead like sandwiches much more for lunch. As such, in this example, the AI creative asset assistant 98 may swap out an image of a pastry with an image of a sandwich in a version of the ad and may cause the updated ad, now including a content indication of the sandwich, to be presented to the communication devices (e.g., UE 30) of one or more users across the platform, network, or the like. In this example, regarding the updated ad (e.g., new version of the ad) of the sandwich, in addition to swapping the pastry with the sandwich, the AI creative asset assistant 98 may also change foreground objects, background objects, text and/or other media content items that were in the ad of the pastry to be included in the updated ad of the sandwich. In this manner, users of a platform, network or the like, may feel that they are presented with newer content, and user interaction/engagement with such newer content may increase.

As such, the AI creative asset assistant 98 may leverage AI to decompose the text, foreground objects, background objects, and other media items of a content asset and may reconfigure the text, foreground objects, background objects, etc. as a different/updated version of the content asset to present the different/updated version of the content assent to the users associated with the platform, network or the like.

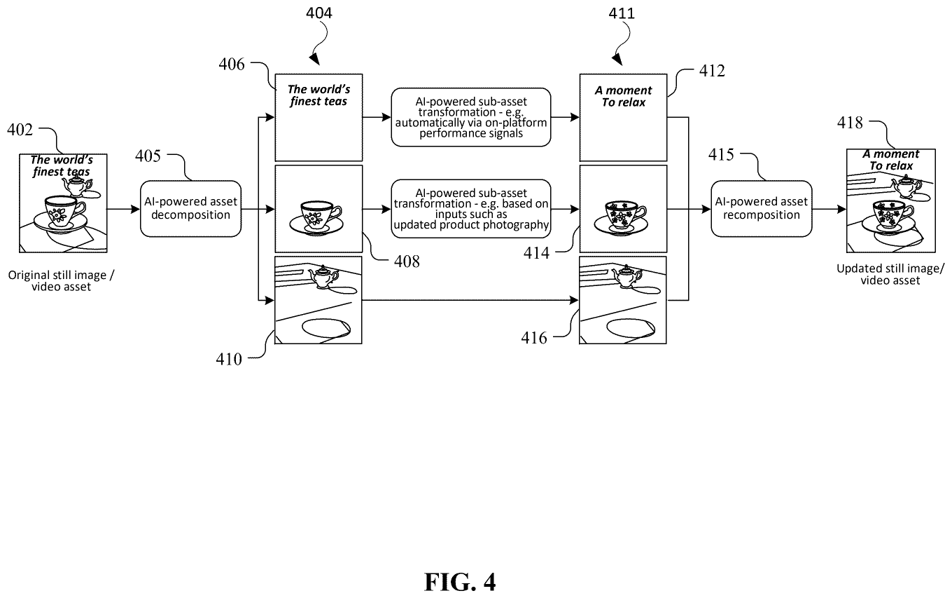

Referring now to FIG. 4, a diagram illustrating refreshing of creative content assets is provided in accordance with example aspects of the present disclosure. In the example of FIG. 4, there may be an original still image and/or video asset 402 presented to one or more users of a platform, network (e.g., system 100), or the like. For purposes of illustration and not of limitation, for example, the original still image/video asset 402 may be associated with an ad, video or other multimedia content that may be presented by a network device (e.g., computing system 300) to one or more communication devices (e.g., UEs 30) of users associated with a network (e.g., system 100). In some other example aspects, the ad, video or other multimedia content associated with the original still image/video asset 402 may, but need not be, an ad, video or other multimedia content of a campaign targeted to one or more users (e.g., a subset(s) of users) of the network.

The AI creative asset assistant 98 may analyze images and/or videos (e.g., original still image/video asset 402) and may perform a decompose operation/step 405 to decompose the images and/or videos into sub-assets including decomposed objects 404 such as for example, text, backgrounds, foregrounds, logos, sound/audio, etc.

The AI creative asset assistant 98 may perform AI recognition to identify/detect the individual objects, text and other content items. The AI creative asset assistant 98 may segment the individual items for separation into images (e.g., images 406, 408, 410). The AI creative asset assistant 98 may perform AI inpainting to fill in holes left by one layer over another layer. For example, the AI creative asset assistant 98 may implement AI inpainting techniques to first mask a region of an image to be inpainted. The AI creative asset assistant 98 may then predict the missing pixels of the region of the image, leveraging a contextual understanding of the image as a whole, and predicting the missing pixels using a combination of convolutional networks and other techniques The AI creative asset assistant 98 may then refine the predicted pixels through multiple iterations to ensure a seamless blend with existing pixels.

The AI creative asset assistant 98 may transform image 406, 408, 410 into image 412, 414, and 416. Additionally, in some example aspects, the AI creative asset assistant 98 may analyze text and may perform a direct image to image transformation on the text, or optical character recognition (OCR) and/or font identification for reproduction and/or transformation of text. In this manner, the AI creative asset assistant 98 may transform the text of image 406 as “The world's finest teas” to the text “A moment To Relax” of image 412.

In some example aspects, the AI creative asset assistant 98 may perform language translation on a first language of the text in the original still image and/or video asset 402 to translate the text of the first language (e.g., English, Mandarin, German, etc.) to text of a second language (e.g., Spanish, Portuguese, Dutch, etc.) based on a determined region in which users that may be presented an updated still image/video asset (e.g., updated still/video asset 418) are located.

As described above, the AI creative asset assistant 98 may transform the text of “The world's finest teas” in image 406 to the text “A moment To Relax” in image 412. In the example of FIG. 4, the AI creative asset assistant 98 may transform the image 408 to the image 414. The AI creative asset assistant 98 may transform the cup of the image 408 to another different cup of image 414. In some examples, the cup of the image 414 may be a different color than a color of the cup of the image 408. The cup of the image 414 may also have a different design (e.g., a different dot pattern, a different circle pattern, etc.) than the design of the cup of image 408. In this example of FIG. 4, the objects of the image 410 and the background of the image 410 may be the same as the objects of the image 416 and the background of the image 416. In some other example aspects, the AI creative asset assistant 98 may transform the image 416 with different objects and a different background than the objects and the background of image 410.

The AI creative asset assistant 98 may perform a recompose operation/step 415 to recompose (e.g., reassemble/combine) images (e.g., images 412, 414, and 416) and/or videos from updated sub-assets 411. The AI creative asset assistant 98 may stack the layers of the images 412, 414, and 416 to reintroduce details such as, for example, shadows under objects as well as the details of the objects, background and foreground of the images 412, 414, 416 as a recomposed (e.g., grouped or combined) image and/or video (e.g., updated still image/video asset 418). The updated still image/video asset 418 may be a refreshed/updated and different image/video or different version of the original still image/video asset 402. In this manner, one or more users associated with a platform, network, or the like may be enticed by the new content of the updated still image/video asset 418 to engage and/or interact with the updated still image/video asset 418 in relation to the original still image/video asset 402.

In some example aspects, in response to the AI creative asset assistant 98 determining that user interaction/user engagement with the original still image/video asset 402 among users of a platform or network (e.g., system 100) is below a predetermined threshold, the AI creative asset assistant 98 may automatically perform the aspects described regarding FIG. 4 to generate the updated still image/video asset 418. In some example aspects, the determining as to whether the user interaction/user engagement with an original still image/video asset among users is below a predetermined threshold may occur during, or associated with, a predetermined time period (e.g., periodically such as weekly, monthly, upon expiration of a time period, etc.). As referred to herein, fatigue, user fatigue, or the like may denote/indicate a decline in the performance of a content item(s) (e.g., a creative content item of a target campaign) over time that may be due to a repeated exposure of the same content item(s) by a target set of users (e.g., a target audience). In some examples, the fatigue/user fatigue may be the decline in the performance of the content item(s) being below a predetermined threshold (e.g., less than 40% (or 50%, etc.) of user engagement/user interaction by users with the content item(s)). The predetermined threshold to determine fatigue/user fatigue may be variable based on a myriad of factors including, but not limited to, norms, costs of presenting content via a network (e.g., ad spend, etc.), target number of users to reach (e.g., target audience size), etc. In some examples, the user engagement/user interaction by users may be determined by the AI creative asset assistant 98 based on determined click rates, and/or view through rates of users associated with content items of a network. As an example, an average click rate for an ad campaign increasing by 30% more (e.g., for 70% total user engagement) in relation to the baseline click rate (e.g., 40% total user engagement) established over first and second time periods for user impressions may trigger automatic generation by the AI creative asset assistant 98 of a new/updated content asset(s)/item(s). The click rates and/or view through rates may be configurable.

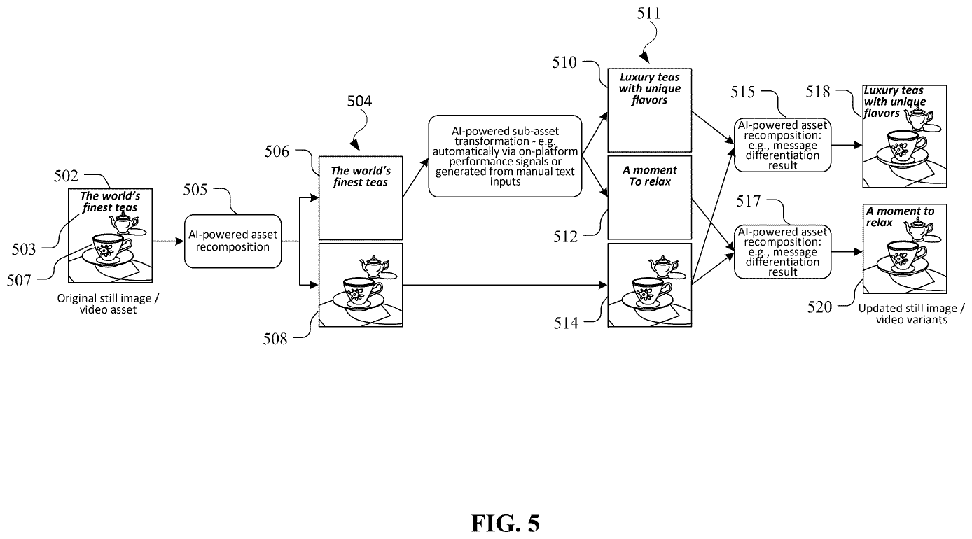

Referring now to FIG. 5, a diagram illustrating creative diversification of content assets is provided in accordance with example aspects of the present disclosure. In the example of FIG. 5, there may be an original still image and/or video asset 502 presented to one or more users associated with a platform, network (e.g., a social network), or the like. For purposes of illustration and not of limitation, for example, the original still image/video asset 502 may be associated with an ad, or other multimedia content, that may be presented by a network device (e.g., computing system 300) to one or more communication devices (e.g., UEs 30) of users associated with a network (e.g., system 100). In some other example aspects, the ad, or other multimedia content of the original still image/video asset 502 may, but need not be, an ad or other multimedia content of a campaign targeted to one or more users (e.g., a subset(s) of users) of the network.

The AI creative asset assistant 98 may analyze images and/or videos (e.g., original still image/video asset 502) and may perform a decompose operation/step 505 to decompose the images and/or videos into sub-assets including decomposed objects 504 such as for example, text, backgrounds, foregrounds, logos, sound/audio, etc. The AI creative asset assistant 98 may decompose images and/or videos of content items/assets such as, for example, original still image/video asset 502 by generating sub-assets (e.g., sub-content assets) of content items that may be varied, and which may be separated, by the AI creative asset assistant 98 from an original asset (e.g., original still image/video asset 502). In this regard, the AI creative asset assistant 98 may segment individual content items (e.g., 503, 507 items) of the original still image/video asset 502 and may separate the items (e.g., items 503, 507) into image 506, and image 508. The AI creative asset assistant 98 may perform AI inpainting to fill in holes left by one layer over another layer.

The AI creative asset assistant 98 may transform the image 506 into two images such as image 510 and image 512. In this regard, for example, the AI creative asset assistant 98 may vary/change the text “The world's finest teas” of the image 506 to “Luxury teas with unique flavors” in the image 510. Additionally, the AI creative asset assistant 98 may vary/change the text “The world's finest teas” of the image 506 to “A moment To relax” in the image 512. In the example of FIG. 5, the AI creative asset assistant 98 may generate a copy of the image 508 to create the same content of image 514 (e.g., a duplicate copy of image 508).

In some example aspects, the AI creative asset assistant 98 may generate the sub-assets 511 that may be varied in the images 510, 512 automatically, or in an automated manner, by implementing determined text generated based on signals associated with a platform, network (e.g., system 100), or the like indicating increased performance and/or that increased user engagement/interaction is likely by presenting the determined text to users of the platform/network. In some other example aspects, the AI creative asset assistant 98 may generate the sub-assets that may be varied in the images 510, 512 in response to receipt of user inputs (e.g., inputs by users (e.g., an administrator) indicating explicit text variants).

The AI creative asset assistant 98 may perform recompose operations/steps 515, 517 to recompose images (e.g., images 510, 512, 514) and/or videos from updated sub-assets 511. The AI creative asset assistant 98 may stack the layers of the image 510 and image 514 as well as image 512 and image 514 to reintroduce details such as, for example, shadows under objects as well as the details of the objects, background items and foreground items of the set of images 510 and 512 to generate a first recomposed (e.g., grouped or combined) image and/or video (e.g., updated still image/video asset 518) and to generated a second recomposed image and/or video (e.g., updated still image/video asset 520).

The updated still image/video assets 518 and 520 may be a refreshed and diversified/varied image/video or different versions of the original still image/video asset 502. In this manner, one or more users associated with a platform, network, or the like may be enticed by the new content of the updated still image/video assets 518 and 520 to engage and/or interact with the updated still image/video assets 518, 520 in relation to the original still image/video asset 502 in which users may be determined to be fatigued with interacting with the original still image/video asset 502.

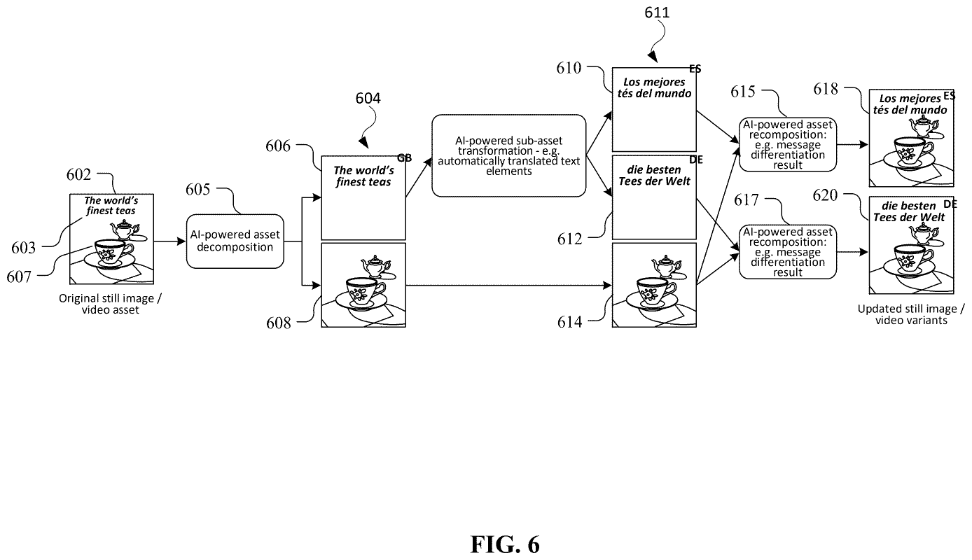

Referring now to FIG. 6, a diagram illustrating creative diversification of content assets associated with localization and/or regionalization is provided in accordance with example aspects of the present disclosure. In the example of FIG. 6, there may be an original still image and/or video asset 602 presented to one or more users associated with a platform, network (e.g., a social network), or the like. For purposes of illustration and not of limitation, for example, the original still image/video asset 602 may be associated with an ad, a video (e.g., a movie, a portion of a movie (e.g., a movie clip)) or other content item (e.g., multimedia content) that may be presented by a network device (e.g., computing system 300) to one or more communication devices (e.g., UEs 30) of users associated with a network (e.g., system 100).

The AI creative asset assistant 98 may analyze images and/or videos (e.g., original still image/video asset 602) and may perform a decompose operation/step 605 to decompose the images and/or videos into constituent sub-assets including decomposed objects 604 such as for example, text, backgrounds, foregrounds, logos, sound/audio, etc. The AI creative asset assistant 98 may decompose images and/or videos of content items/assets such as, for example, original still image/video asset 602 by generating sub-assets (e.g., sub-content assets) of content items that may be varied, and which may be separated, by the AI creative asset assistant 98 from an original asset (e.g., original still image/video asset 602). In this regard, the AI creative asset assistant 98 may segment individual content items (e.g., items 603, 607) of the original still image/video asset 602 and may separate the items (e.g., items 603, 607) into image 606, and image 608. The AI creative asset assistant 98 may perform AI inpainting to fill in holes left by one layer over another layer.

For purposes of illustration and not of limitation, for example, the AI creative asset assistant 98 may determine that a current determined region associated with the original still image/video asset 602 to be presented to one or more users associated with a platform, or network (e.g., system 100) is Great Britian (GB) and that the text “The world's finest teas” of the image 606 is in the English language. The AI creative asset assistant 98 may generate detected text overlay images (e.g., image 610 and image 612) that may be automatically translated in target languages (e.g., Spanish and German languages). In some example aspects, the target languages may be selected by the AI creative asset assistant 98 automatically relative to expected performance signals associated with a platform, network or the like. In some examples, content assets/items may be targeted to specific regions, and these regions (e.g., Spain, England) may be used to designate target languages (e.g., Spanish language, English language) for presentation to one or more users in the regions. In some other examples, content assets/items may be provided to one or more users based on the users designated geographic area (e.g., Italy) and the users language preferences (e.g., Italian language) indicated in the user profiles of the users. In some other example aspects, the AI creative asset assistant 98 may determine the target languages in response to receipt of one or more inputs (e.g., by one or more users (e.g., an administrator, etc.)) indicating one or more target languages.

The AI creative asset assistant 98 may translate the text of the image 604 in English such as “The world's finest teas” to text in the selected/detected target languages (e.g., Spanish, German) and may present the translated text in images and/or videos (e.g., image 610 and image 612).

In the example of FIG. 6, the AI creative asset assistant 98 may determine that an updated content asset (e.g., an update to original still image/video asset 602) may need to be presented to users determined to be located in a region such as Spain (ES) in Spanish text (e.g., “Los mejores tés del mundo” in image 610) and that an updated content asset may need to be presented to users determined to be located in a region such as Germany (DE) in German text (e.g., “die besten Tees der Welt” in image 612).

In the example of FIG. 6, the AI creative asset assistant 98 may generate a copy of the image 608 to generate the same content of image 614 (e.g., a duplicate copy of image 608). In this regard, the background objects of the image 608 and the background objects of the image 614 may be the same background.

The AI creative asset assistant 98 may perform recompose operations/steps 615, 617 to recompose images (e.g., images 610, 612, 614) and/or videos from updated constituent sub-assets 611. The AI creative asset assistant 98 may stack the layers of the image 610 and image 614 as well as the layers of image 612 and image 614 to reintroduce details such as, for example, shadows under objects as well as the details of the objects, background items and foreground items of the set of images 610 and 612 to generate a first recomposed (e.g., grouped or combined) image and/or video (e.g., updated still image/video asset 618) and to generated a second recomposed image and/or video (e.g., updated still image/video asset 620). The updated still image/video asset 618 may include the translated text of “The world's finest tea” in Spanish such as “Los mejores tés del mundo”. Additionally, the updated still image/video asset 620 may include the translated text of “The world's finest tea” in German such as “die besten Tees der Welt”.

The updated still image/video assets 618 and 620 may be a refreshed/updated and diversified/varied image/video or different version of the original still image/video asset 602. In this manner, one or more users associated with a platform, network, or the like may be enticed by the new content of the updated still image/video assets 618 and 620 to engage and/or interact with the updated still image/video assets 618, 620 in relation to the original still image/video asset 602. For instance, in the example of FIG. 6, a first set of users, associated with a network, determined to be located in a region such as, for example, Spain may be enticed to engage/interact with updated still image/video assets 618. In addition, a second set of users, associated with a network, determined to be located in a region such as, for example, Germany may be enticed to engage/interact with updated still image/video assets 620.

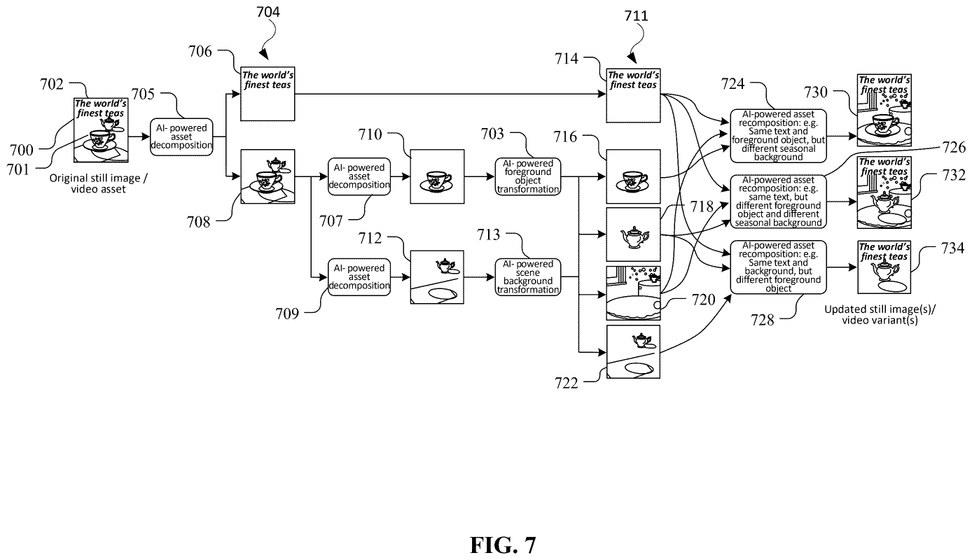

Referring now to FIG. 7, a diagram illustrating another example of creative diversification of content assets is provided in accordance with example aspects of the present disclosure. In the example of FIG. 7, there may be an original still image and/or video asset 702 presented to one or more users associated with a platform, network (e.g., a social network), or the like. For purposes of illustration and not of limitation, for example, the original still image/video asset 702 may be associated with an ad, a video (e.g., a movie, video clip, etc.), or other multimedia content item that may be presented by a network device (e.g., computing system 300) to one or more communication devices (e.g., UEs 30) of users associated with a network (e.g., system 100).

The AI creative asset assistant 98 may analyze images and/or videos (e.g., original still image/video asset 702) and may perform a decompose operation/step 705 to decompose the images and/or videos into constituent sub-assets including decomposed objects 704 such as for example, text, backgrounds, foregrounds, logos, sound/audio, etc. In this regard, the AI creative asset assistant 98 may segment individual content items (e.g., 700, 701 items) of the original still image/video asset 702 and may separate the items (e.g., items 700, 701) into image 706, and image 708. The AI creative asset assistant 98 may perform AI inpainting to fill in holes left by one layer over another layer.

In the example of FIG. 7, the image 706 may include a foreground and one or more objects such as for example text indicating “The world's finest teas”. The image 708 may include a background and one or more objects such as for example an image of a cup, plate and other objects. The AI creative asset assistant 98 may create a duplicate image of the image 706 as an image 714 during the decomposition operation/step 705. In this regard, the image 714 also includes the foreground and one or more objects such as the text indicating “The world's finest teas”. The AI creative asset assistant 98 may perform decomposition operations/steps 707, and 709 to segment one or more first objects (e.g., a cup on a plate) of the image 708 to a transformed image 710 and to segment one or more second set of objects (e.g., a teapot and a plate) of the image 708 to a transformed image 712. In this regard, for example the AI creative asset assistant 98 may perform a foreground object transformation operation/step 703 on the image 710 to generate an image 716 having the image of the cup on the plate in the foreground, or may perform a foreground object transformation on the cup to generate an image of a teapot image 718, and may perform a background object transformation operation/step 713 on image 712 to generate images 720, and 722. The images 720 and 722 may be variants/variations of image 712 having one or more different objects in the background of the images 720 and 722. In some example aspects, the various images 716, 718, 720 and 722 may be generated by the AI creative asset assistant 98 automatically based in part on one or more determined signals associated with a platform or network (e.g., system 100) indicating increased performance or a probability (e.g., greater than 70% increase in user interaction, etc.) of increased user engagement/interaction with the content elements/items of images 716, 718, 720 and 722 is likely/expected (e.g., seasonal background at specific times of the year). In some other example aspects, the various images 716, 718, 720 and 722 may be generated by the AI creative asset assistant 98 based in part on receipt/detection of input from one or more users (e.g., an administrator, etc.). The input may be user input of one or more designated object variants.

By performing the foreground object transformation operation/step 703 and the background object transformation operation/step 711, the AI creative asset assistant 98 may transform image elements of images 716, 718, 720 and 722 such as, for example, various foreground objects and background objects.

In response to performing recomposition operations/steps 724, 726, and 728 on images 714, 716, 718, 720 and 722, the AI creative asset assistant 98 may generate various updated still images/video variants 730, 732 and 734. In this regard, the updated still image/video variant 730 may include the same text such as “The world's finest teas” as image 714 and a same foreground object as image 716 and may have a different seasonal background than a background of original still image/video asset 702.

Additionally, the updated still image/video variant 732 may include the same text such as “The world's finest teas” as image 714 and a same foreground object as image 716 and may have a different foreground object and a different seasonal background than the foreground and background objects of original still image/video asset 702. Furthermore, the updated still image/video variant 734 may include the same text such as “The world's finest teas” as image 714 and a same background object as image 712 and may have a different foreground object than a foreground object of the original still image/video asset 702.

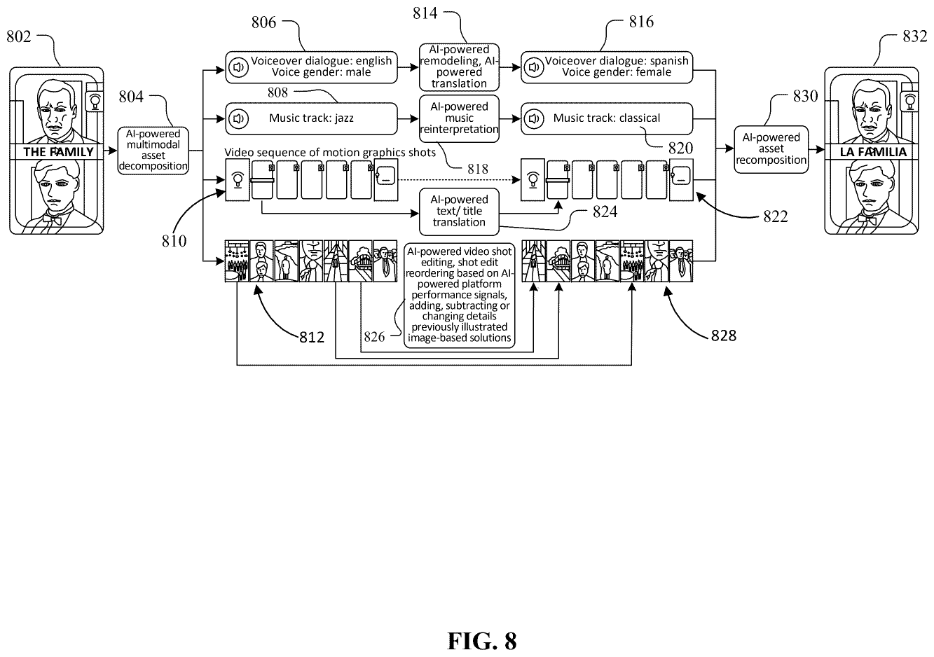

Referring now to FIG. 8, a diagram illustrating video and audio refresh and diversification of content assets is provided in accordance with example aspects of the present disclosure. In the example of FIG. 8, there may be an original video asset 802 presented to one or more users associated with a platform, network (e.g., system 100), or the like. In some examples, the original video asset 802 may be a movie. In other examples, the original video asset 802 may be any other suitable video content (e.g., a video clip, animation, etc.).

The AI creative asset assistant 98 may analyze the original video asset 802 and may detect one or more content items as sub-assets that may be varied to create variations that may be separated from the original video asset 802. The AI creative asset assistant 98 may analyze the original video asset 802 to determine individual objects, text, audio, motion graphics overlays and/or the like of original video asset 802.

In this regard, the AI creative asset assistant 98 may segment individual content items associated with the original video asset 802 and may separate the individual content items into images (e.g., the video sequence of motion graphic shots 810). The AI creative asset assistant 98 may perform AI inpainting to fill in holes left by one layer over another when separating the individual content items into images.

The AI creative asset assistant 98 may perform/implement a multimodal asset decomposition operation/step 804 to decompose multimodal sub-assets (e.g., sub-content assets) including images, video, audio and/or other content items associated with the original video asset 802 to understand constituent parts of the original video asset 802.

In this regard, for example, in response to performing the multimodal asset decomposition operation/step 804, the AI creative asset assistant 98 may determine a voice classification 806 such as a voiceover dialogue, a perceived/determined gender of a person speaking associated with the dialogue, tonal qualities and mood of the person speaking and a language of the dialogue (e.g., English language). For example, the AI creative asset assistant 98 may perform multimodal analyses of content items (e.g., video content) and may utilize the multimodal analyses to make inferences about a mood associated with a voice speaking or speech data (e.g. an upbeat mood for Christmas or seasonal content, or a more somber mood associated with a public service announcement).

In response to performing the multimodal asset decomposition operation/step 804, the AI creative asset assistant 98 may also perform audio compression on the original video asset 802 to identify and separate multiple tracks of the original video asset 802 as well as separate speech (e.g., voice speech) and other audio of the original video asset 802. For instance, the AI creative asset assistant 98 may perform audio classification 808 to classify audio tracks as belonging to a particular genre (e.g., music track jazz), having a particular mood, or the like.

In response to performing the multimodal asset decomposition operation/step 804, the AI creative asset assistant 98 may also perform/implement video and image classification to identify/determine one or more motion graphics elements 812 (e.g., video shots/clips), logos, mood and content of individual video shot(s) associated with a video sequence of the original video asset 802.

The AI creative asset assistant 98 may perform a remodeling and translation operation 814 on the voice classification 806 to generate a voice classification 816. In this regard, the AI creative asset assistant 98 may transform the voiceover dialogue in the English language and the perceived/determined voice gender being a male voice of voice classification 806 to an associated voiceover dialogue in the Spanish language and a perceived/determined gender voice being a female voice of the voice classification 816. In response to implementing the remodeling and translation operation 814, the AI creative asset assistant 98 may reproduce and facilitate output of spoken dialogue (e.g., speech data, voice data) with a different voice (e.g., a female voice) and in one or more different languages (e.g., Spanish, Portuguese, etc.) than a voice (e.g., male voice) and a language (e.g., English) of an initial corresponding content asset (e.g., a video clip of a video sequence (e.g., a movie)).

The AI creative asset assistant 98 may also perform a music reinterpretation operation 818 on the music track jazz 808 to vary/change the music track jazz to music track classical 820. The AI creative asset assistant 98 may perform a text/title translation operation 824 to translate one or more of the items of text in a first language (e.g., English, German, Dutch, Mandarin, etc.) in the items of a video sequence of motion graphics shots 810 to one or more items of other text in a second language (e.g., Spanish, Portuguese, Italian, etc.) associated with the items of video sequence of motion graphics shots 822. In this regard, in response to implementing/performing the text/title translation operation 824, the AI creative asset assistant 98 may translate text in motion graphics elements in a language to one or more different languages.

In response to performing the video shot editing operation 826, the AI creative asset assistant 98 may utilize performance signals associated with a platform, network or the like indicating a manner in which a video sequence of video shots/clips 812 should be generated in a resequencing order of video shots/clips 828 in which the signals may indicate a higher performance may be achieved with regard to determining that users of the platform, network (e.g., system 100), or the like may be more inclined to engage/interact with the re-sequenced order of video shots/clips 828 than the sequence of video shots/clips 812.

Additionally, in response to the AI creative asset assistant 98 performing/implementing the asset recomposition operation/step 830, the AI creative asset assistant 98 may intelligently reassemble multi-modal sub-assets (e.g., the voice classification 816 associated with voice dialogue in the Spanish language and a gender voice of a female, music track classical 820) to generate a video asset 832. The video asset 832 may also have associated audio content. In this regard, a network device (e.g., computing system 300) may provide the video asset 832 to one or more users of a network (e.g., system 100). As such, the communication devices (e.g., UEs 30) of the one or more users may be presented with the video asset 832 and the one or more users may be enticed to engage/interact with the video asset 832 via their communication devices since the video asset 802 may be generated by the AI creative asset assistant 98 in response to the AI creative asset assistant 98 determining that the user interaction and/or user engagement with the original video asset 802 by the one or more users of the network is below a predetermined threshold (e.g., less than 40% (or 50%, etc.) user engagement) for example during, or associated with, a predetermined time period (e.g., daily, weekly, monthly, etc.). The predetermined threshold may be configurable based in part on preferences of a content asset entity associated with a network (e.g., system 100). Some examples of preferences may be seasonal times of year, holiday periods, or the like which may render a previous version of a content item presented by the network obsolete (e.g., no longer relevant for the current moment).

The reassembled multi-modal sub-assets of (or associated with) the video asset 832 may for example include, but are not limited to, the voice classification 816 associated with voice dialogue in the Spanish language and a gender voice of a female, as well as a music track classical 820. Additionally, the multi-modal sub-assets of the video asset 822 may include a title “LA FAMILIA” translated in the Spanish language, which may be translated from the text “THE FAMILY” in the English language in the original video asset 802.

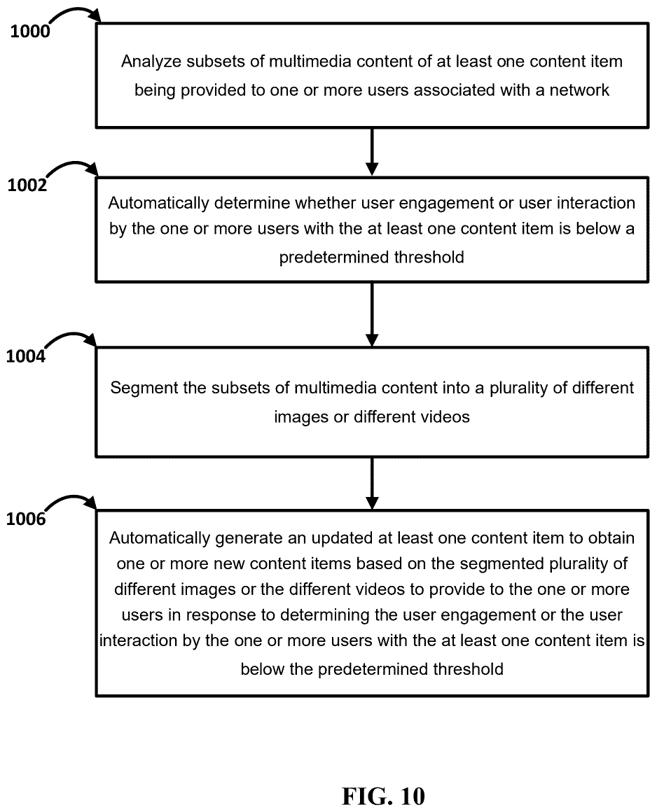

FIG. 9 illustrates an example of a machine learning framework 900 including machine learning model(s) 930 and a training database 950, in accordance with one or more examples of the present disclosure. The training database 950 may store training data 920. In some examples, the machine learning framework 900 may be hosted locally in a computing device or hosted remotely. By utilizing the training data 920 of the training database 950, the machine learning framework 900 may train the machine learning model(s) 930 to perform one or more functions, described herein, of the machine learning model(s) 930. In some examples, the machine learning model(s) 930 may be stored in a computing device. For example, the machine learning model(s) 930 may be embodied within a communication device (e.g., computing system 300). In some other examples, the machine learning model(s) 930 may be embodied within another device (e.g., UE 30). Additionally, the machine learning model(s) 930 may be processed by one or more processors (e.g., processor 32 of FIG. 2, coprocessor 81 of FIG. 3). In some examples, the machine learning model(s) 930 may be associated with operations (or performing operations) of FIG. 10. In some other examples, the machine learning model(s) 930 may be associated with other operations. In some examples, the machine learning model(s) 930 may be an example of the AI creative asset assistant 98.

The training data 920 employed by the machine learning model(s) 930 may be pre-trained, fixed or updated periodically. Alternatively, the training data 920 may be updated in real-time based upon the evaluations performed by the machine learning model(s) 930 in a non-training mode. This may be illustrated by the double-sided arrow connecting the machine learning model(s) 930 and stored training data 920 which may be stored in the training database 950. Some other examples of the training data 920 may include, but are not limited to, items of content determined as being associated with a platform (e.g., a social network, etc.), a network (e.g., system 100, the Internet, etc.), or the like.

Some of the training data 920 of the machine learning model(s) 930 may include multiple languages, text content, objects, audio data, user dialogue, user conversations, voice gender determinations, music genres, images (e.g., pictures, photographs), animation content, video content (e.g., video clips, movies, etc.), one or more signals indicating one or more content assets/items determined as enhancing or increasing the probability of user engagement or user interaction with one or more content items/assets and any other suitable data (e.g., multimedia content). In some example aspects, such training data 920 may be obtained based on user data of users associated with a system (e.g., system 100). In addition, training data 920 may be based on content items of one or more content asset libraries. For example, a library of ads, videos, images and other content items in which the library may also include determined tones of prior captured/detected voices, an art direction style(s), content determined from multimodal analyses (e.g., analyses of voice data/speech data, etc.). Furthermore, training data 920 may be based on data available/associated with a network (e.g., the Internet). In some example aspects, users may opt in with a network or system (e.g., system 100) to enable usage of user data to be utilized as training data 920.

The training data 920 may be utilized to train the machine learning model(s) 930 to predict/determine one or more best content items in which to update/refresh content (e.g., based on current/existing content) being presented to one or more users associated with a network or to predict/determine and provide one or more new items of content to the one or more users associated with the network. The prediction/determination of the one or more new content items may be in response to determining there is user fatigue with an original content item(s) or a prior version of content being presented to the one or more users associated with the network). Additionally, as described above, the machine learning model(s) 930 may be trained at an initial stage, in real-time and/or trained periodically (e.g., updated periodically).

In an example, the training data 920 may include attributes of thousands of objects. For example, the objects may be posters, brochures, billboards, menus, goods (e.g., packaged goods), books, groceries, Quick Response (QR) codes, smart home devices, home and outdoor items, household objects (e.g., furniture, kitchen appliances, etc.) and any other suitable objects. In some other examples, the objects may be smart devices (e.g., UEs 30, communication devices 105, 110, 115, 120), persons (e.g., users), newspapers, articles, flyers, pamphlets, signs, cars, content items (e.g., messages, notifications, text content, images, animations, videos, audio content), and/or the like. Attributes may include, but are not limited to, the size, shape, orientation, position/location of the object(s), text, etc.

FIG. 10 illustrates an example flowchart illustrating operations for providing automated creative diversification of content items/assets according to an example of the present disclosure. At operation 1000, a device (e.g., AI creative asset assistant 98 of computing system 300) may analyze subsets of multimedia content of at least one content item (e.g., original still image/video asset 402) being provided to one or more users associated with a network (e.g., system 100). At operation 1002, a device (e.g., AI creative asset assistant 98) may automatically determine whether user engagement or user interaction by the one or more users with the at least one content item is below a predetermined threshold.

At operation 1004, a device (e.g., AI creative asset assistant 98) may segment the subsets of multimedia content into a plurality of different images or different videos (e.g., images 406, 408, 410). At operation 1006, a device (e.g., AI creative asset assistant 98) may automatically generate an updated at least one content item to obtain one or more new content items (e.g., updated still image/video asset 418) based on the segmented plurality of different images or the different videos to provide to the one or more users in response to determining the user engagement or the user interaction by the one or more users with the at least one content item is below the predetermined threshold.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

1. A method comprising:
analyzing, by a network device, at least one content item being provided to one or more users associated with a network, wherein the at least one content item comprises a plurality of multimedia elements;
automatically determining whether user engagement or user interaction by the one or more users with the at least one content item is below a predetermined threshold;
segmenting the at least one content item into a plurality of sub-assets, wherein individual sub-assets of the plurality of sub-assets comprise individual multimedia elements of the plurality of multimedia elements;
varying a first multimedia element of a first sub-asset of the plurality of sub-assets to generate a varied sub-asset comprising a second multimedia element that is different from the first multimedia element; and
automatically generating, by the network device, one or more new content items to provide to the one or more users in response to determining the user engagement or the user interaction by the one or more users with the at least one content item is below the predetermined threshold, wherein automatically generating the one or more new content items comprises recombining the varied sub-asset with a second sub-asset of the plurality of sub-assets.

2. The method of claim 1, further comprising:
implementing a machine learning model comprising training data, pre-trained, or trained in real-time, comprising one or more signals indicating one or more content assets determined as enhancing or increasing the probability of other user engagement or other user interaction with the one or more new content items in relation to the user engagement or the user interaction with the at least one content item by the one or more users.

3. The method of claim 2, wherein:
the automatically generating the one or more new content items comprises the implementing of the machine learning model by the network device.

4. The method of claim 1, wherein the one or more new content items are associated with the at least one content item.

5. The method of claim 1, further comprising:
automatically providing, by network device, the one or more new content items to one or more communication devices of the one or more users.

6-7. (canceled)

8. The method of claim 1, wherein prior to the automatically generating, the method comprises:
determining that one or more signals associated with the network indicate that the likelihood of new user engagement or new user interaction by the one or more users is increased by providing the one or more new content items to the one or more users.

9. The method of claim 1, further comprising:
determining that an instance in which the user engagement or the user interaction is below the predetermined threshold indicates that at least a subset of the one or more users are disinterested in engaging or interacting with the at least one content item.

10. The method of claim 1, further comprising:
determining locations or regions of at least a first subset of the one or more users;
wherein the first multimedia element comprises text content or audio content in a first language associated with a second subset of the one or more users; and
wherein varying the first multimedia element comprises automatically translating the text content or the audio content into a second language associated with the first subset of the one or more users.

11. The method of claim 1, wherein the plurality of multimedia elements comprise one or more of background content, foreground content, text data, objects, logos, audio content, video content, or images.

12. An apparatus comprising:
one or more processors; and
at least one memory storing instructions, that when executed by the one or more processors, cause the apparatus to:
analyze at least one content item being provided to one or more users associated with a network, wherein the at least one content item comprises a plurality of multimedia elements;
automatically determine whether user engagement or user interaction by the one or more users with the at least one content item is below a predetermined threshold;
segment the at least one content item into a plurality of sub-assets, wherein individual sub-assets of the plurality of sub-assets comprise individual multimedia elements of the plurality of multimedia elements;
vary a first multimedia element of a first sub-asset of the plurality of sub-assets to generate a varied sub-asset comprising a second multimedia element that is different from the first multimedia element; and
automatically generate one or more new content items to provide to the one or more users in response to determining the user engagement or the user interaction by the one or more users with the at least one content item is below the predetermined threshold, wherein to automatically generate the one or more new content items, the apparatus is configured to recombine the varied sub-asset with a second sub-asset of the plurality of sub-assets.

13. The apparatus of claim 12, wherein when the one or more processors execute the instructions, the apparatus is configured to:
implement a machine learning model comprising training data, pre-trained, or trained in real-time, comprising one or more signals indicating one or more content assets determined as enhancing or increasing the probability of other user engagement or other user interaction with the one or more new content items in relation to the user engagement or the user interaction with the at least one content item by the one or more users.

14. The apparatus of claim 13, wherein when the one or more processors execute the instructions, the apparatus is configured to:
perform the automatically generate the one or more new content items by the implement of the machine learning model.

15. The apparatus of claim 12, wherein when the one or more processors execute the instructions, the apparatus is configured to:
automatically provide the one or more new content items to one or more communication devices of the one or more users.

16-17. (canceled)

18. The apparatus of claim 12, wherein prior to the automatically generate, when the one or more processors execute the instructions, the apparatus is configured to:
determine that one or more signals associated with the network indicate that the likelihood of new user engagement or new user interaction by the one or more users is increased by providing the one or more new content items to the one or more users.

19. A non-transitory computer-readable medium storing instructions that, when executed, cause:
analyzing, by a network device, at least one content item being provided to one or more users associated with a network, wherein the at least one content item comprises a plurality of multimedia elements;
automatically determining whether user engagement or user interaction by the one or more users with the at least one content item is below a predetermined threshold;
segmenting the at least one content item into a plurality of sub-assets, wherein individual sub-assets of the plurality of sub-assets comprise individual multimedia elements of the plurality of multimedia elements;
varying a first multimedia element of a first sub-asset of the plurality of sub-assets to generate a varied sub-asset comprising a second multimedia element that is different from the first multimedia element; and
automatically generating, by the network device, one or more new content items to provide to the one or more users in response to determining the user engagement or the user interaction by the one or more users with the at least one content item is below the predetermined threshold, wherein automatically generating the one or more new content items comprises recombining the varied sub-asset with a second sub-asset of the plurality of sub-assets.

20. The computer-readable medium of claim 19, wherein the instructions, when executed, further cause:
implementing a machine learning model comprising training data, pre-trained, or trained in real-time, comprising one or more signals indicating one or more content assets determined as enhancing or increasing the probability of other user engagement or other user interaction with the one or more new content items in relation to the user engagement or the user interaction with the at least one content item by the one or more users.
